(19) United States
(12) Patent Application Publication
(10) Pub. No.: US 2003/0081079 A1
(43) Pub. Date: May 1, 2003

(54) Ink jet recording head, method for manufacturing the same and ink jet recording apparatus

(75) Inventors: Masashige Mitsuhashi, Tokyo (JP); Shigeru Umehara, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/246,438

(22) Filed: Sep. 19, 2002

(30) Foreign Application Priority Data
Sep. 20, 2001 (JP) P. 2001-287357

(51) Int. Cl. B41J 2/045

(52) U.S. Cl. 347/68

(57) ABSTRACT

A method for manufacturing an ink jet recording head of a type having a plurality of pressure chambers communicating with an ink chamber and arrayed two-dimensionally, and a plurality of piezoelectric elements driving the pressure chambers, respectively, the piezoelectric elements being actuated to apply pressure to ink in the pressure chambers and thereby eject ink droplets from nozzles communicating with the pressure chambers, respectively, the manufacturing method includes the steps of patterning a piezoelectric plate releasably bonded to a substrate, forming a piezoelectric element unit in which a plurality of piezoelectric elements are arrayed two-dimensionally on the substrate, bonding the piezoelectric elements of the piezoelectric element unit to a diaphragm plate; and then releasing the substrate from the piezoelectric elements.

The present disclosure relates to the subject matter contained in Japanese Patent Application No.2001-287357 filed on Sep. 20, 2001, which are incorporated herein by reference in its entirety.

### BACKGROUND OF THE INVENTION

1. Field of the Invention

The present invention relates to an ink jet recording head which can be incorporated in information equipment such as a word processor, a facsimile machine or a printer, a method for manufacturing such an ink jet recording head, and an ink jet recording apparatus mounted with such an ink jet recording head. It particularly relates to an ink jet recording head designed to be mass-produced easily while having piezoelectric elements arrayed two-dimensionally and mounted with high density, a method for manufacturing such an ink jet recording head, and an ink jet recording apparatus mounted with such an ink jet recording head.

2. Description of the Related Art

In recent years, non-impact recording systems command interest because noise during recording is extremely low and printing can be carried out at a high speed. Of them, ink jet printers using ink jet recording systems are in widespread use. The ink jet printers are designed to fly ink droplets from a recording head and attach the ink droplets to recording paper so as to perform printing of characters, drawings, pictures and the like at a high speed. The ink jet printers can perform recording on plain paper without having any special fixing treatment or the like subjected to the plain paper. As such an ink jet recording system, there has been known a drop on-demand type ink jet system in which electromechanical transducers such as piezoelectric elements are used to generate pressure waves (acoustic waves) in pressure chambers filled with ink so as to eject ink droplets from nozzles communicating with the pressure chambers.

A recording head of a drop on-demand type ink jet system (hereinafter, referred to as “ink jet recording head”) is, for example, disclosed in JP-A-56-64877. FIGS. 11A to 11C show an ink jet recording head disclosed in this official gazette. FIG. 11A is a longitudinal sectional view of a main portion, FIG. 11B is a partially broken plan view thereof, and FIG. 11C is a sectional view taken on line c-c in FIG. 11B.

In the ink jet recording head, a base plate 44 and a diaphragm plate 42 are joined to each other so as to form pressure chambers 45 between the base plate 44 and the diaphragm plate 42 and form orifices 43 in one-side end portions of the pressure chambers 45. The orifices 43 form ink nozzles. In addition, rectangular piezoelectric elements 41 are joined onto the diaphragm plate 42, and a pulse generator 40 is electrically connected to the piezoelectric elements 41. The pressure chambers 45 are supplied with ink from an ink tank 47 through an ink supply tube 46. The piezoelectric elements 41 are composed of piezoelectric ceramic, particularly PZT (lead titanate zirconate).

In the related-art ink jet recording head, the piezoelectric elements 41 are produced by processing a piezoelectric ceramic plate into a shape of predetermined dimensions by machining. Examples of such a high-precision processing method of the piezoelectric elements 41 include a dicing saw system of cutting or grooving by rotation of a disc (dicing blade) containing diamond grains, and a wire saw system. However, such a high-precision processing method of piezoelectric elements is suitable for linear processing, but incapable of forming a piezoelectric ceramic plate (piezoelectric plate) into a desired shape (JP-A-11-129476)

For example, JP-A-11-207970 discloses a manufacturing method for forming a piezoelectric plate into a desired shape. The manufacturing method disclosed in this official gazette is just as follows. First, a blowing agent sheet is pasted on dummy glass, and a piezoelectric film is placed and pasted thereon. A resist is disposed thereon, and a mask portion is patterned. The piezoelectric film other than the portion covered with the mask portion is ground by sandblasting. Next, the resist is peeled off, and the piezoelectric film is aligned with the ink chamber and placed on a conductive film on a diaphragm plate. Then, the dummy glass is taken off. Further, an electrode is formed on the piezoelectric film by lamination. According to such a manufacturing method, the piezoelectric film can be formed into a desired shape in accordance with the mask pattern.

In the field of ink jet recording heads in recent years, however, there is considered a recording head in which a large number of nozzles are arrayed two-dimensionally so as to suppress increase in head size and achieve high-density is mounting of nozzles (hereinafter, referred to as “matrix array head”). In the methods disclosed in the related-art examples, there are shown a plurality of piezoelectric elements arrayed one-dimensionally simply, but there is no description on the point that a large number of piezoelectric elements arrayed two-dimensionally with high density are obtained in the form of a matrix array head.

### SUMMARY OF THE INVENTION

In consideration of the problem, an object of the invention is to provide a method for manufacturing an ink jet recording head in which a large number of piezoelectric elements arrayed two-dimensionally with high density in the form of a matrix array head can be manufactured easily by a simple manufacturing process while a piezoelectric plate is formed into a desired shape, and to provide an ink jet recording head manufactured in such a manufacturing method, and an ink jet recording apparatus mounted with such an ink jet recording head.

It is another object of the invention to provide a method for manufacturing an ink jet recording head having good ground condition in a piezoelectric plate when the piezoelectric plate is subjected to patterning, particularly sandblasting.

In order to attain the foregoing objects, according to a first aspect of the invention, a method for manufacturing an ink jet recording head having a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers, respectively, the piezoelectric elements being actuated to apply pressure to ink in the pressure chambers and thereby eject ink droplets from nozzles communicating with the pressure chambers, respectively, the manufacturing method includes the steps of:

bonding a piezoelectric plate to a substrate releasably;

applying a mask film to the piezoelectric plate;

forming the mask film into a piezoelectric element mask pattern for forming an area as a unit of the piezoelectric elements;

sandblasting from above the pattern mask so as to pattern the piezoelectric plate and thereby form the piezoelectric element unit in which a plurality of piezoelectric elements are arrayed two-dimensionally on the substrate; and

bonding the piezoelectric elements of the piezoelectric element unit to the diaphragm plate, and then releasing the substrate from the piezoelectric elements.

The “piezoelectric plate” in this specification means ceramic plate before the production of piezoelectric elements.

In the method for manufacturing an ink jet recording head according to the first aspect, only if the piezoelectric plate is patterned in the state where the piezoelectric plate is bonded to the substrate releasably, the piezoelectric plate can be cut into a desired shape easily and a plurality of piezoelectric elements releasable from the substrate individually can be obtained simply. Further, the piezoelectric elements can be formed as a piezoelectric element unit in which a plurality of piezoelectric elements are arrayed on the substrate two-dimensionally. Thus, a large number of piezoelectric elements arrayed two-dimensionally with high density in the form of a matrix array head can be manufactured easily by a simple manufacturing process.

Here, when the piezoelectric plate is patterned, sandblasting is carried out on the piezoelectric plate. Thus, it is possible to pattern the piezoelectric plate easily regardless of the number of piezoelectric elements or the array form thereof.

JP-A-2001-88303 and JP-A-2000-79686 disclose techniques for batch-transfer of a plurality of piezoelectric elements formed. In either of these techniques, a plurality of piezoelectric elements are formed on a substrate not by sandblasting but by photolithography, screen printing, or the like. Thus, the manufacturing process is not easy. To the contrary, in the manufacturing method according to the invention, a plurality of piezoelectric elements formed on a substrate by patterning such as sandblasting can be collectively handled in the form of a unit. Thus, though comparatively inexpensive equipment is used, not only the step of forming a large number of piezoelectric elements but also the step of bonding the piezoelectric elements to the walls of the pressure chambers respectively become easy and simple. In such a manner, according to this manufacturing method, the manufacturing process becomes simple and easy so that mass production of matrix array heads each mounted with a large number of piezoelectric elements with high density becomes easy.

According to a second aspect of the invention, a method for manufacturing an ink jet recording head, for manufacturing an ink jet recording head having a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers respectively, the piezoelectric elements being actuated to apply pressure to ink in the pressure chambers and thereby eject ink droplets from nozzles communicating with the pressure chambers, respectively, the manufacturing method includes the steps of:

pasting a mask film on a piezoelectric plate;

forming the mask film into a pattern mask including a piezoelectric element mask pattern for forming an area as a unit of the piezoelectric elements, and an outer circumferential dummy mask pattern for forming an outer circumferential dummy pattern as the outer circumference of the piezoelectric element unit; and

sandblasting from above the pattern mask so as to pattern the piezoelectric plate.

In the method for manufacturing an ink jet recording head according to the invention as in (2), it is possible to obtain effect similar to that of the method for manufacturing an ink jet recording head defined in (1). In addition, the outer circumferential dummy pattern is formed in the outer circumferential area of the piezoelectric element unit. Thus, the influence of side etching caused by sandblasting is prevented so that high dimensional uniformity can be secured in the piezoelectric elements.

That is, when sandblasting is carried out on the piezoelectric plate, processing in the width direction of the piezoelectric plate also makes progress in parallel with the progress of processing (etching) in the thickness direction of the piezoelectric plate. The processing in the width direction of the piezoelectric plate is referred to as side etching in this specification. The side etching is caused by collision of blasting grains also with the side surfaces of the piezoelectric plate when sandblasting is carried out.

Then, the processing rate of the side etching depends on the width of a processed groove to be formed in the piezoelectric plate. That is, the larger the width of the processed groove to be formed at the side of each piezoelectric element is, the more easily the blasting grains collide with the side surfaces of the piezoelectric plate. Thus, the progress rate of side etching increases. Since sandblasting has such a characteristic, side etching appears violently in piezoelectric elements located in the outer circumferential portion of the piezoelectric element unit. That is, no obstacle preventing blasting grains from colliding with the side surfaces is provided at the side of the piezoelectric elements in the outer circumferential portion. Thus, side etching makes progress at an extremely high rate. Accordingly, the piezoelectric elements in the outer circumferential portion deteriorate considerably in dimensional accuracy. The dimensions of the piezoelectric elements have a great influence on the ejection properties (such as droplet volume and droplet speed). It is therefore necessary to prevent uneven side etching as described above.

In the method for manufacturing an ink jet recording head according to the invention, therefore, an outer circumferential dummy pattern is disposed to surround the piezoelectric element unit. As a result, side etching can be prevented from occurring violently in the piezoelectric elements in the outer circumferential portion so that the piezoelectric element unit can be formed to have high dimensional uniformity.

Incidentally, for example, JP-A-9-39234, JP-A-6-143563 and JP-A-2000-289200 disclose techniques for forming dummy piezoelectric elements making no contribution to application of pressure to pressure chambers. However, the techniques disclosed in these official gazettes are merely to improve the mechanical strength in joining a pedestal or the like, on which piezoelectric elements are provided, to a diaphragm plate. It is therefore impossible to expect the effect of the invention “to produce only piezoelectric elements superior in ground condition” from the techniques of these official gazettes.

Here, it is desired that the piezoelectric plate is bonded to a substrate releasably before the step of pasting the mask film. Then, a piezoelectric element unit in which a plurality of piezoelectric elements are arrayed two-dimensionally on the substrate is formed, and the piezoelectric elements of the piezoelectric element unit are bonded to the diaphragm plate. After that, the substrate is released from the piezoelectric elements. As a result, a plurality of piezoelectric elements formed on the substrate by sandblasting can be collectively handled in the form of a unit. Thus, though comparatively inexpensive equipment is used, not only the step of forming a large number of piezoelectric elements but also the step of bonding the piezoelectric elements to the walls of the pressure chambers respectively become easy and simple. In such a manner, according to this manufacturing method, the manufacturing process becomes simple and easy so that mass production of matrix array heads mounted with a large number of piezoelectric elements with high density becomes easy.

According to a third aspect of the invention, a method for manufacturing an ink jet recording head for manufacturing an ink jet recording head having a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers respectively, the piezoelectric elements being actuated to apply pressure to ink in the pressure chambers and thereby eject ink droplets from nozzles communicating with the pressure chambers, respectively, the manufacturing method includes the steps of:

pasting a mask film on a piezoelectric plate;

forming the mask film into a pattern mask having a piezoelectric element mask pattern for forming an area as a unit of the piezoelectric elements, and a remaining dummy pattern in the piezoelectric element unit for making gaps around the piezoelectric elements substantially uniform in dimensions; and

sandblasting from above the pattern mask so as to pattern the piezoelectric plate.

Accordingly, the progress rate of side etching can be made uniform also on the piezoelectric elements in the piezoelectric element unit so that the dimensional uniformity of the piezoelectric elements can be further improved. That is, as described above, the progress rate of side etching varies in accordance with the width of a processed groove surrounding the piezoelectric elements. Therefore, a remaining dummy pattern is formed between adjacent ones of the piezoelectric elements so that all the gaps around the piezoelectric elements are made substantially uniform. Thus, the progress rate of side etching on all of the piezoelectric elements can be made uniform so that it is possible to obtain piezoelectric elements high in dimensional uniformity.

Here, it is likewise desired that the piezoelectric plate is bonded to a substrate releasably before the step of pasting the mask film. Then, a piezoelectric element unit in which a plurality of piezoelectric elements are arrayed two-dimensionally on the substrate is formed, and the piezoelectric elements of the piezoelectric element unit are bonded to the diaphragm plate. After that, the substrate is released from the piezoelectric elements.

Incidentally, a more preferable mode can be formed if both the outer circumferential dummy pattern described in the manufacturing method according to the second aspect and the remaining dummy pattern described in the manufacturing method, according to the third aspect are provided.

It is further preferable to provide the step of forming marks on the substrate and/or the piezoelectric plate at the same time as the sandblasting step. The marks are used for positioning the piezoelectric elements of the piezoelectric element unit when the piezoelectric elements are bonded to the diaphragm plate.

As the marks used for positioning, marks formed in the following step can be used. In this step, for example, first through-holes are formed in the substrate and second through-holes are formed in the diaphragm plate forming the walls of the pressure chambers, while positioning marks are formed on the pressure chamber plate having the pressure chambers. When the piezoelectric element unit is formed, alignment marks substantially corresponding to the positions of the first through-holes and smaller than the first through-holes, together with separation grooves arrayed, two-dimensionally for separating the piezoelectric elements from one another, are formed on the piezoelectric plate by sandblasting. Further, the piezoelectric elements on the pressure chamber plate are joined to the diaphragm plate while the first through-holes, the alignment marks, the second through-holes and the positioning marks are adjusted to one another with reference to the alignment marks. In this case, since the first through-holes larger than the alignment marks are formed on the substrate in accordance with the pitch of the alignment marks, alignment can be performed easily from the back side of the substrate.

In addition, it is preferable that the walls of the pressure chambers are made of the diaphragm plate, and the positioning marks used as reference for joining the diaphragm plate to the piezoelectric element unit are formed on the diaphragm plate in advance, while apertures for being optically aligned with the positioning marks are formed in the substrate at the same time as sandblasting. In this case, the apertures which will be required in a subsequent step may be formed at the same time as patterning by sandblasting or the like in the step of separating the piezoelectric elements. As a result, the piezoelectric elements can be collectively positioned and joined with high accuracy to the diaphragm plate facing the pressure chambers corresponding to the piezoelectric elements without accumulating, any variation in alignment accuracy.

It is further preferable that the piezoelectric plate is bonded to the substrate through a thermo-expandable adhesive film. When the substrate is released from the piezoelectric element unit, the substrate is heated to reduce the adhesive force of the thermo-expandable adhesive film. Thus, the step of bonding the piezoelectric element unit with the substrates and the step of releasing the substrate after bonding become extremely easy.

In addition, another preferable mode can be obtained as follows. That is, a vapor deposition step of forming an insulating resin film on each side surface of each piezoelectric element is provided between the step of forming the piezoelectric element unit and the step of bonding the piezoelectric elements to the diaphragm plate. In the vapor deposition step, the substrate in which the surface of the piezoelectric element unit is covered with the mask film is tilted at a predetermined angle with the vertical direction and rotated on its axis while being allowed to revolve around an evaporation source. In this case, the insulating resin film can be deposited and formed on each side surface of each piezoelectric element uniformly and in good condition. By the insulating resin film on each side surface of each piezoelectric element, dielectric breakdown of the piezoelectric elements is prevented from being caused by water absorption from the air, so that the reliability can be improved.

Preferably, the piezoelectric element unit and the diaphragm plate are bonded to the walls of the pressure chambers by a conductive adhesive agent. In this case, even if a metal thin film is formed on each surface of the piezoelectric elements abutting against the pressure chamber walls, the piezoelectric elements with the metal thin film can be firmly and surely attached to the pressure chamber walls without damaging the good conductivity.

It is also a preferable mode that the sandblasting is carried out for a longer time than minimum regular processing time required in accordance with the thickness of the piezoelectric plate. In this case, for example, sandblasting may be carried out for a time two to four times as long as the regular processing time. Thus, it is possible to obtain an excellent, two-dimensionally arrayed piezoelectric element unit in which the separation grooves between adjacent ones of the piezoelectric elements separated by sandblasting are made uniform in shape.

By the sandblasting, separation grooves substantially uniform in width may be formed to extend in directions of the rows and columns of the piezoelectric elements so as to separate the piezoelectric elements from one another. In this case, processed grooves (separation grooves) of the piezoelectric elements can be formed by sandblasting so as to be uniform in sectional shape.

Preferably, the piezoelectric elements, are joined in a state where at least one-side ends of the piezoelectric elements are placed on the walls of the pressure chambers respectively while the other-side ends of the piezoelectric elements are placed above the pressure chambers respectively. Thus, the one-side ends of the piezoelectric elements can be fixed to the diaphragm plate of the pressure chamber plate portion so that displacement can be produced in the diaphragm plate on the apertures in accordance with the expansion and contraction of the piezoelectric elements.

It is further preferable that a flexible wiring board is mechanically and electrically connected through solder bumps to the surfaces of the piezoelectric elements on the walls of the pressure chambers. In this case, since the flexible wiring board is connected through the solder bumps to the surfaces of the piezoelectric elements positioned and joined onto the walls of the pressure chambers, the pressure at the time of solder bump connection can be set to be large so that the joint strength can be improved. Further, since the solder bumps can be connected to a control portion through the flexible wiring board, reliable connection can be made even if there is a variation in height among the solder bumps.

The ink jet recording head according to the invention has a plurality of pressure chambers communicating with an ink chamber and arrayed two-dimensionally, a diaphragm plate forming parts of wall surfaces of the pressure chambers, and a plurality of piezoelectric elements joined to the diaphragm, plate correspondingly to the pressure chambers respectively, the piezoelectric elements being actuated to apply pressure to ink in the pressure chambers and thereby eject ink droplets from nozzles communicating with the pressure chambers respectively, wherein an insulating resin film is formed on each side surface of each piezoelectric element.

In the ink jet recording head according to the invention, it is possible to obtain a configuration in which piezoelectric elements arrayed two-dimensionally are mounted with high density, while an insulating resin film is formed on each side surface of each piezoelectric element. Thus, dielectric breakdown of the piezoelectric elements is prevented from being caused by water absorption from the air, so that the reliability can be improved.

The ink jet recording head according to the first aspect of the invention has a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers respectively, the piezoelectric elements being actuated to apply pressure to ink in the pressure chambers and thereby eject ink droplets from nozzles communicating with the pressure chambers respectively, wherein the piezoelectric elements are arrayed two-dimensionally on the diaphragm plate forming the walls of the pressure chambers, and an outer circumferential dummy pattern is formed around the piezoelectric elements.

In the ink jet recording head according to the first aspect, an outer circumferential dummy pattern is formed in the outer circumference of the piezoelectric elements arrayed two-dimensionally so that the outer circumferential dummy pattern can take charge of the portion to be processed much by side etching caused by sandblasting. It is therefore possible to produce piezoelectric elements with high dimensional accuracy.

The ink jet recording head according to a second aspect of the invention has a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers respectively, the piezoelectric elements being actuated to apply pressure to ink in the pressure chambers and thereby eject ink droplets from nozzles communicating with the pressure chambers respectively, wherein the piezoelectric elements are arrayed two-dimensionally on the diaphragm plate forming the walls of the pressure chambers, and a remaining dummy pattern is formed between adjacent ones of the piezoelectric elements so as to make all the gaps around the piezoelectric elements substantially uniform in dimensions.

According to the ink jet recording head according to the second aspect, the progress rate of side etching can be made uniform all over the piezoelectric elements in the piezoelectric element unit. It is therefore possible to obtain piezoelectric elements superior in dimensional uniformity.

In addition, the ink jet recording head according to a third aspect of the invention has a plurality of pressure chambers communicating with an ink chamber and arrayed two-dimensionally, a diaphragm plate forming parts of wall surfaces of the pressure chambers, and a plurality of piezoelectric elements joined to the diaphragm plate correspondingly to the pressure chambers respectively, the piezoelectric elements being actuated to apply pressure to ink in the pressure chambers and thereby eject ink droplets from nozzles communicating with the pressure chambers respectively, wherein the ink jet recoding head further has a pressure chamber plate having the pressure chambers, and a piezoelectric plate in which the plurality of piezoelectric elements are formed while positioning marks are formed on the pressure chamber plate, and wherein through-holes in which the positioning marks are fit in position are formed in the diaphragm plate, and alignment marks are formed on the piezoelectric plate.

According to the ink jet recording head according to the third aspects, it is possible to obtain an effect that the pressure chambers and the piezoelectric elements can be aligned with each other accurately through the diaphragm plate

In addition, the ink jet recording apparatus according to the invention is an ink jet recording apparatus mounted with any one of the ink jet recording heads described above. Accordingly, it is possible to obtain an ink jet recording apparatus in which the dimensional uniformity of the piezoelectric elements is extremely high and scattering in properties among ejectors can be accordingly prevented so that a high-quality image can be output.

### BRIEF DESCRIPTION OF THE DRAWINGS

FIG. 1 is a sectional view showing the main portion configuration of an ink jet recording head according to a first embodiment of the invention.

FIG. 2 is a plan view taken on line II-II in FIG. 1, showing the positional relationship between a plurality of square piezoelectric elements and nozzles arrayed two-dimensionally in the first embodiment.

FIG. 3 is a schematic view showing the state where a piezoelectric element pattern is formed in the first embodiment.

FIGS. 4A and 4B are sectional views showing different, shapes of a piezoelectric plate in the first embodiment, FIG. 4A showing the state of FIG. 3 in which a piezoelectric element pattern has been formed, FIG. 4B showing a piezoelectric plate after sandblasting has been performed on the piezoelectric plate of FIG. 4A.

FIGS. 5A and 5B are sectional views showing a piezoelectric element unit formed by sandblasting in the first embodiment, FIG. 5A showing a result obtained by sandblasting for regular time, FIG. 5B showing a result obtained by sandblasting for time three times as long as the regular time.

FIG. 6 is a front view showing the mode in which insulating resin is formed by vapor deposition on each of the four side surfaces of each piezoelectric element in the first embodiment.

FIG. 7 is a sectional view showing the state where a square piezoelectric element unit on which an insulating resin film is formed has been bonded to a diaphragm plate in the first embodiment.

FIG. 8 is a sectional view showing the main portion configuration of an ink jet recording head according to a second embodiment of the invention.

FIG. 9 is a plan view taken on line IX-IX in FIG. 8, showing the positional relationship between a plurality of rectangular piezoelectric elements and nozzles arrayed two-dimensionally, dummy patterns and alignment patterns in the second embodiment.

FIG. 10 is a sectional view showing the state that a rectangular piezoelectric element unit has been bonded to a diaphragm plate in the second embodiment.

FIGS. 11A to 11C show a related-art ink jet recording head, FIG. 11A being a longitudinal sectional view of a main portion, FIG. 11B being a partially broken plan view, FIG. 11C being a sectional view taken on line c-c.

FIG. 12 is a perspective view showing an ink jet recording apparatus according to a third embodiment of the invention.

### DETAILED DESCRIPTION OF THE PREFERRED EMBODIMENTS

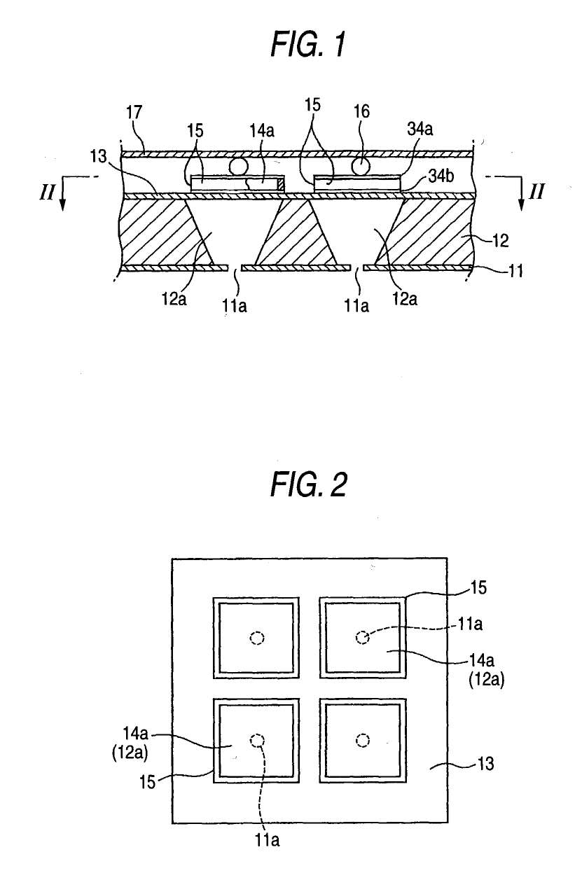

The invention will be described further in detail on the basis of its embodiments with reference to the drawings. FIG. 1 is a sectional view showing a main portion of an ink jet recording head according to a first embodiment of the invention.

First Embodiment

This embodiment shows an example of an ink jet recording head provided with piezoelectric elements each having a square shape identical to that of each pressure chamber. This ink jet recording head has a nozzle plate 11, a pressure chamber plate 12 and a diaphragm plate 13. In the nozzle plate 11, a plurality of nozzles 11a are formed two-dimensionally. The pressure chamber plate 12 is provided on the nozzle plate 11. In the pressure chamber plate 12, a plurality of pressure Chambers 12a are formed to communicate with the nozzles 11a, respectively. The diaphragm plate 13 is bonded to face the respective pressure chambers 12a.

On the surface of the diaphragm plate 13 opposite to the pressure chambers 12a, a plurality of piezoelectric elements 14a are arrayed two-dimensionally in a matrix manner manner so as to face the pressure chambers 12a, respectively. An insulating resin film 15 is formed on each side surface of each piezoelectric element 14a, while first and second electrode layers 34a and 34b are formed on the upper and lower surfaces of each piezoelectric element 14a, respectively. Each pressure chamber 12a has a substantially quadrangular pyramid shape tapered gradually from the diaphragm plate 13 side toward the nozzle 11a. In each piezoelectric element 14a, the first electrode layer 34a is mechanically and electrically connected to a wiring layer 17 through a solder ball bump 16 while the second electrode layer 34b is bonded with the diaphragm plate 13 through a conductive adhesive agent. A driving voltage from a not-shown control portion is applied to each piezoelectric element 14a through the wiring layer 17 and the solder ball bump 16.

FIG. 2 is a plan view taken on line II-II in FIG. 1, showing the positional relationship between the plurality of piezoelectric elements 14a and the nozzles 11a arrayed two-dimensionally. The plurality of nozzles 11a are arrayed in a a matrix manner in the nozzle plate 11 while the plurality of piezoelectric elements 14a facing the nozzles 11a are arrayed in a matrix manner on the diaphragm plate 13. Each piezoelectric element 14a has a square shape and is positioned to place one nozzle 11a in its center position surrounded by the insulating resin films 15 on the four side surfaces of the piezoelectric element 14a.

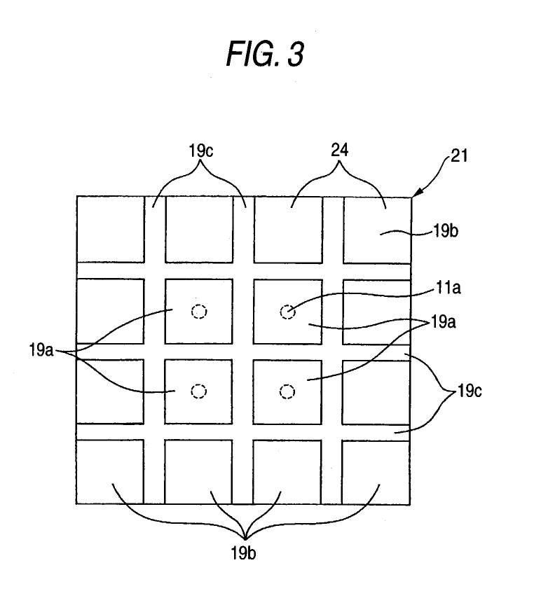

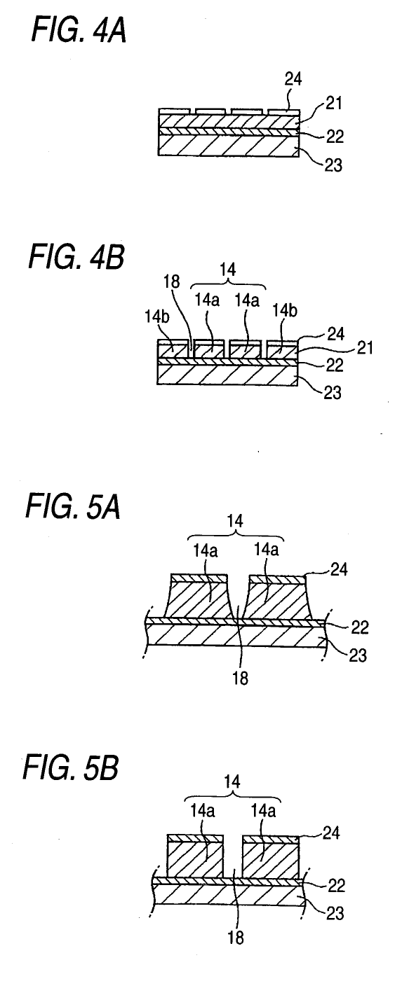

Next, description will be made on a method for manufacturing the ink jet recording head configured thus. First, to produce the piezoelectric elements 14a, a rectangular piezoelectric plate 21 (FIG. 4) is prepared, and a piezoelectric element mask pattern and an outer circumferential dummy mask pattern are formed on the piezoelectric plate 21, as shown in FIG. 3. FIG. 3 is a view schematically showing the state where a piezoelectric element pattern and an outer circumferential dummy pattern are formed in accordance with the formation of the piezoelectric element mask pattern and the outer circumferential dummy mask pattern.

In the step of forming the patterns, first, a photosensitive film 24 is pasted all over the piezoelectric plate 21, and covered with a grid-like mask (not shown). In this state, the photosensitive film 24 is exposed and developed. By the photosensitive film 24 hardened and surviving in squares by the development, a piezoelectric element mask pattern for forming a piezoelectric element pattern 19a and an outer circumferential dummy mask pattern for forming an outer circumferential dummy pattern 19b surrounding the piezoelectric element pattern 19a are obtained. The area which is not covered with the pattern mask having the piezoelectric element mask pattern and the outer circumferential dummy mask pattern is eliminated so that a groove pattern 19c extending in the directions of rows and columns is obtained.

FIGS. 4A and 4B show stepwise different shapes of the piezoelectric plate. FIG. 4A is a side sectional view corresponding to the state of FIG. 3 in which the piezoelectric element pattern has been formed. FIG. 4B is a side sectional view showing a piezoelectric plate after sandblasting is carried out on the piezoelectric plate shown in FIG. 4A.

In FIG. 4A, one surface of the piezoelectric plate 21 is fixedly bonded to a flat-plate substrate 23 through an adhesive film 22 having thermo-expandability. On the other surface of the piezoelectric plate 21, a piezoelectric element mask pattern and an outer circumferential dummy mask pattern for forming the piezoelectric element pattern 19a and the outer circumferential dummy pattern 19b are formed by use of the photosensitive film 24 shown in FIG. 3, respectively. The thermo-expandable adhesive film 22 has a property to be expanded to cause great reduction in the adhesive force when heated at predetermined temperature after adhesion.

FIG. 4B shows the state after sandblasting for blasting minute abrasives has been carried out from above the photosensitive film 24 by use of an abrasive blasting apparatus (not shown). In FIG. 4B, the piezoelectric plate 21 fixedly bonded onto the substrate 23 is ground in accordance with the piezoelectric element mask pattern and the outer circumferential dummy mask pattern. Thus, piezoelectric elements 14a and dummy elements 14b separated from one another by separation grooves 18 are obtained. In addition, since the outer circumferential dummy pattern 19b (FIG. 3) is provided, side etching which might be easily produced in piezoelectric elements in the outer circumferential portion can be prevented. Thus, the piezoelectric elements 14a obtained are arrayed uniformly two-dimensionally. Incidentally, here, the number of the piezoelectric elements 14a is set at four, and the number of the dummy elements 14b surrounding a piezoelectric element unit 14 constituted by the four piezoelectric elements 14a is set at 12. However, the numbers are not limited thereto.

FIGS. 5A and 5B are sectional views showing the piezoelectric element unit 14 formed by sandblasting. FIG. 5A shows a result obtained by sandblasting carried out for regular time, while FIG. 5B shows a result obtained by sandblasting carried out for time three times as long as the regular time. When sandblasting has been carried out for the regular time, a separation groove 18 between piezoelectric elements 14a is formed obliquely as shown in FIG. 5A. On the other hand, when the sandblasting time has been set at three times as long as the regular time, the inclined shape of the separation groove 18 in FIG. 5A is corrected and improved to result in a vertical separation groove 18 as shown in FIG. 5B. Thus, the piezoelectric elements 14a are separated from each other in good condition. Incidentally, the regular time may be minimum processing time required in accordance with the thickness of the piezoelectric plate. The regular time also may be time required to just divide the piezoelectric plate into the piezoelectric element units.

In this embodiment, the piezoelectric plate 21 is applied to a substrate 23 which can be eliminated after the transfer step which will be described later. Thus, even if the sandblasting time is set at three times as long as the regular time as described above, sandblasting can be carried out sufficiently to form the vertical separation grooves 18 without causing any problem of damaging of any other member.

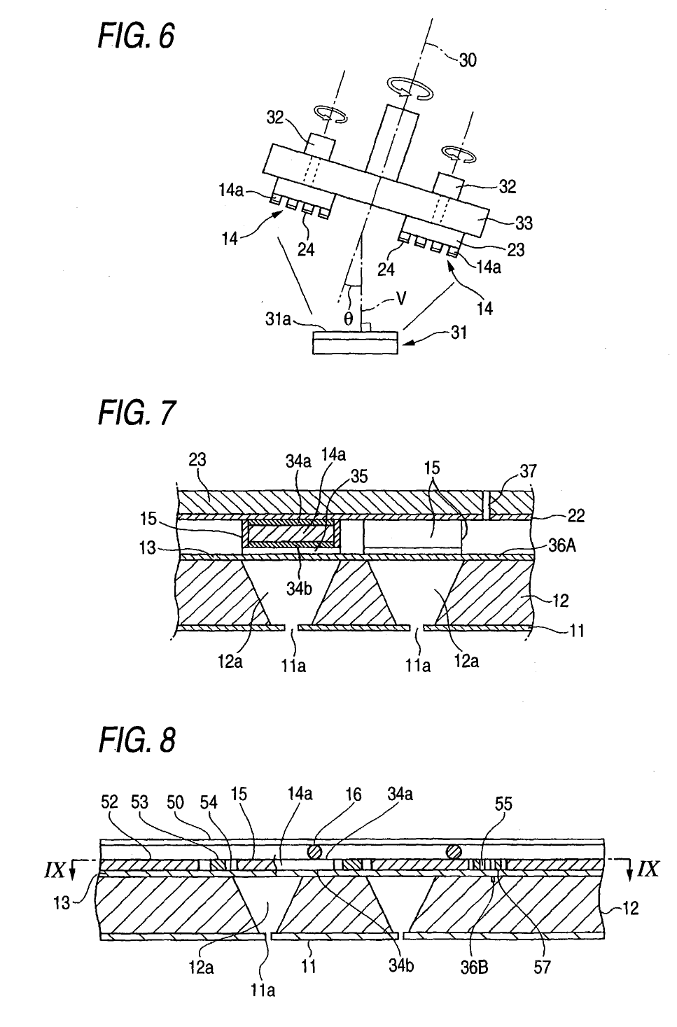

FIG. 6 is a front view showing a state where an insulating resin 15 (see FIGS. 1 and 2) is formed on the four side surfaces of each piezoelectric element 14a by vapor deposition. This vapor deposition step can be carried out while a plurality of piezoelectric elements, 14a separated from one another by the separation grooves 18 are collectively handled as a piezoelectric element unit 14.

The vapor deposition step is carried out between the step of forming the piezoelectric element unit 14 and the step of bonding the respective piezoelectric elements 14a to the diaphragm plate 13, by use of an evaporation apparatus which will be described below. This evaporation apparatus has an evaporation source 31 including an evaporation material such as polyamide, a disc-like substrate holder 33 for holding the substrate 23 to which the piezoelectric element unit 14 has been fixed, and a vacuum chamber (not shown) for receiving the evaporation source 31 and the substrate holder 33. The substrate holder 33 rotates around a first shaft 30 tilted at an angle θ with respect to a vertical line V drawn down to an aperture 31a of the evaporation source 31. The substrate holder 33 has a plurality of second shafts 32 located at an equal distance from the first shaft 30 and for holding substrates 23 at their leading ends.

In the vapor deposition step, first, as shown in FIG. 6, the substrates 23 on which the piezoelectric element unit 14 including the piezoelectric elements 14a each covered with the photosensitive film 24 is formed are fixed to the leading ends of the second shafts 32. Then, in the state where the vacuum chamber is kept evacuated, the respective shafts 32 are, rotated on their axes in one and the same direction while the substrate holder 33 is rotated around the first shaft 3 so gas to make an orbital motion. Thus, the insulating resin film 15 is formed uniformly by vapor deposition on each of the four side surfaces of each piezoelectric element 14a of each piezoelectric element unit 14. By the formation of the insulating resin film 15, dielectric breakdown of the piezoelectric elements 14a is surely prevented from being caused by water absorption from the air, so that the reliability can be improved.

FIG. 7 is a sectional view showing a state where the piezoelectric element unit 14 on which the insulating resin film 15 is formed has been bonded to the diaphragm plate 13. First, the pressure chamber plate 12 and the diaphragm plate 13 are joined onto the nozzle plate 11 sequentially. Then, the surfaces of the respective piezoelectric elements 14a opposite to the substrate 23 are aligned with and joined to the diaphragm plate 13. At this time, a cruciform positioning mark 36A which will be used as reference at the time of joint between the piezoelectric element unit 14 and the diaphragm plate 13 is formed in the diaphragm plate 13 in advance. On the other hand, an aperture 37 for being optically aligned with the positioning mark 36A is formed in the substrate 23 at the same time as sandblasting.

Accordingly, the piezoelectric elements 14a arrayed two-dimensionally can be collectively joined onto the diaphragm plate 13 (the walls of the pressure chambers 12a) with high accuracy while the positioning mark 36A is detected optically through the aperture 37 by an optical microscope. At this time, the first and second electrode layers 34a and 34b are formed as electrode layers on the both sides of each piezoelectric element 14a, respectively, by a sputtering method in advance. The second electrode layer 34b is bonded to the diaphragm plate 13 by a conductive adhesive agent 35.

Successively, the substrate 23 is released from the respective piezoelectric elements 14a fixed to the diaphragm 13. At that time, the substrate 23 is heated to reduce the adhesive force of the thermo-expandable adhesive film 22. Thus, the step of separating the piezoelectric element unit 14 from the substrate 23 becomes extremely easy.

Example of First Embodiment

In this example, there was prepared a nozzle plate 11 in which a plurality of nozzles 11a each having a diameter of 30 μm±0.05 μm were formed in the form of a two-dimensional array of 64 rows by 4 columns. A diaphragm plate 13 made of stainless steel was joined to the nozzle plate 11, so as to face pressure chambers 12a communicating with the nozzles 11a, respectively, as shown in FIG. 1.

Next, a sheet of piezoelectric plate 21 made of lead titanate, zirconate and having a thickness of 30 μm was bonded with a substrate 23 by use of a thermo-expandable adhesive film (e.g. Revalpha (registered trademark)) 22. After that, patterning was performed on the piezoelectric plate 21 by use of a urethane-based photosensitive film 24. In this patterning, a pattern mask including a piezoelectric element mask pattern for forming a piezoelectric element pattern 19a corresponding to four piezoelectric elements 14a and an outer circumferential dummy mask pattern for forming an outer circumferential dummy pattern 19b in the outer circumference of the piezoelectric element pattern 19a was formed.

Successively, silicon carbide abrasive grains (abrasive grain size: e.g. 20 μm) were blasted from above the pattern mask at a predetermined pressure (e.g. 2 kg/cm²). Thus, sandblasting was performed on the piezoelectric plate 21. Here, on the assumption that the time (regular processing time) required for groove penetration in the thickness direction of the piezoelectric plate 21 by sandblasting was 2 seconds, 6 seconds three times as long as the regular processing time was set as the processing time. As a result, the shape of each separation groove 18 which is inclined as shown in FIG. 5A when sandblasting was performed for the regular processing time was corrected as shown in FIG. 5B. Thus, the grooves 18 were improved to result in vertical grooves each having a width of 80 μm in sectional shape.

Thus, the piezoelectric elements 14a each having a shape 500 μm±10 μm square and 30 μm±1 μm thick were obtained. When sandblasting was performed without disposing the outer circumferential dummy pattern, there occurred a variation of ±50 μm or more in the piezoelectric element width in the outer circumferential portion. In comparison with this fact it can be said that the effect obtained by disposing the outer circumferential dummy pattern is very high. In addition, the sandblasting time is several seconds, which is extremely shorter than the time for any other step. Thus, there is no large influence on productivity even if the sandblasting time is set at three times as long as the regular processing time. Incidentally, although the example has shown the case where the outer circumferential dummy pattern was formed as shown in FIG. 3, the outer circumferential dummy pattern may be formed as an integral structure.

Next, while the piezoelectric element unit 14 after the sandblasting was kept adhering to the substrate 23, an insulating resin film 15 made of polyamide and having a thickness of 10 μm was formed by vapor deposition on each of the four side surfaces of each piezoelectric element 14a. An evaporation apparatus used at this time had an evaporation source 31 including polyamide as evaporation material, and a substrate holder 33 rotating around a first shaft 30 tilted at an angle of 15° with respect to the vertical line V drawn down to the evaporation source 31, as shown in FIG. 6. The substrate holder 33 was provided with a plurality of second shafts 32 located at an equal distance from the first shaft 30.

In the vapor deposition step, the substrate 23 covered with the photosensitive film 24 was fixed to the leading end of the second shaft 32. Then, the substrate 23 was rotated on its axis, that is, around the second shaft 32, while the substrate holder 33 is rotated around the first shaft 30 so as to make an orbital motion. Thus, the insulating resin film 15 having a thickness of 10 μm was formed uniformly by vapor deposition on each of the side surfaces of each piezoelectric element 14a.

Next, the surface of the piezoelectric element unit 14 opposite to the thermo-expandable adhesive film 22 was joined onto the diaphragm plate 13 while the positioning mark 36A on the diaphragm plate 13 was aligned with the aperture 37 by an optical microscope viewing through the aperture 37. Thus, the piezoelectric element unit 14 of the piezoelectric elements 14a arrayed in a matrix manner of 64 rows by 4 columns was collectively jointed to the diaphragm plate 13 with high accuracy within ±15 μm. Here, a 0.2 μm thick metal thin film made of Cr and a 0.1 μm thick metal thin film made of Au were sequentially formed as the electrode layers 34a and 34b on the both sides of each piezoelectric element 14a, respectively, by a sputtering method in advance. The electrode layer 34b was bonded with the diaphragm plate 13 by a conductive adhesive agent (paste) 35.

After that, the substrate 23 was heated to reduce the adhesive force of the thermo-expandable adhesive film 22. Then, the substrate 23 was released from the respective piezoelectric elements 14a. Further, each piezoelectric element 14a was connected to a control portion (not shown) through, a solder ball bump 16 and wiring 17. In, the ink jet recording head manufactured thus, the piezoelectric elements 14a were driven in good condition by a driving voltage of 30 V and at a frequency of 30 kHz, so that ink droplets could be ejected from the corresponding nozzles 11a, respectively.

Second Embodiment

Next, description will be made on a second embodiment according to the invention. In this embodiment, an ink jet recording head having piezoelectric elements each having a rectangular shape different from the square shape of each pressure chamber is given as an example. FIG. 8 is a sectional view showing the main portion configuration of the ink jet recording head according to this embodiment.

This ink jet recording head has a nozzle plate 11, a pressure chamber plate 12 and a diaphragm plate 13. In the nozzle plate 11, a plurality of nozzles 11a are formed two-dimensionally. The pressure chamber plate 12 is provided on the nozzle plate 11. In the pressure chamber plate 12, a plurality of pressure chambers 12a are formed to communicate with the nozzles 11a, respectively. The diaphragm plate 13 is bonded to face the respective pressure chambers 12a.

On the surface of the diaphragm plate 13 opposite to the pressure chambers 12a, a plurality of piezoelectric elements 14a are arrayed two-dimensionally so as to face the pressure chambers 12a, respectively. Each pressure chamber 12a has an aperture having a square shape in top view. The rectangular piezoelectric elements 14a, are joined to the diaphragm plate 13 so that their surface end portions are located on the walls of the pressure chambers 12a, that is, portions of the pressure chamber plate 12, respectively.

An insulating resin film 15 is formed on each side surface of each piezoelectric element 14a, while first and second electrode layers 34a and 34b are formed on the upper and lower surfaces of each piezoelectric element 14a, respectively.

Each pressure chamber 12a has a substantially quadrangular pyramid shape tapered gradually from the diaphragm plate 13 side toward the nozzle 11a. The first electrode layer 34a is mechanically and electrically connected to a flexible wiring board 50 through a solder ball bump 16 while the second electrode layer 34b is bonded with the diaphragm plate 13 through a conductive adhesive agent. A driving voltage from a not-shown control portion is applied to each piezoelectric element 14a through the flexible wiring board 50 and the solder ball bump 16.

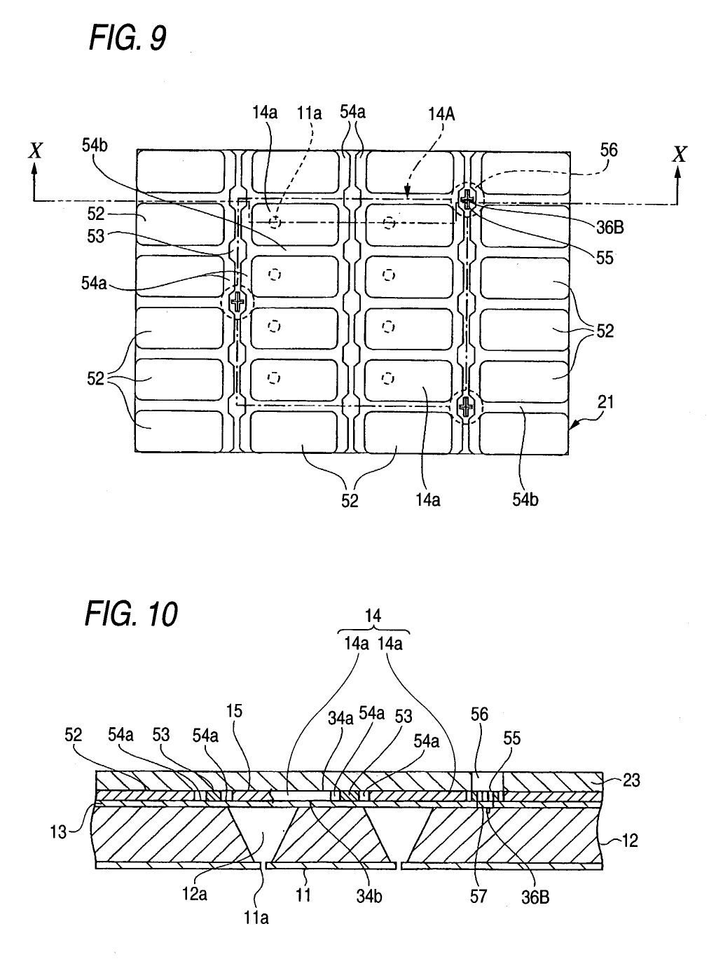

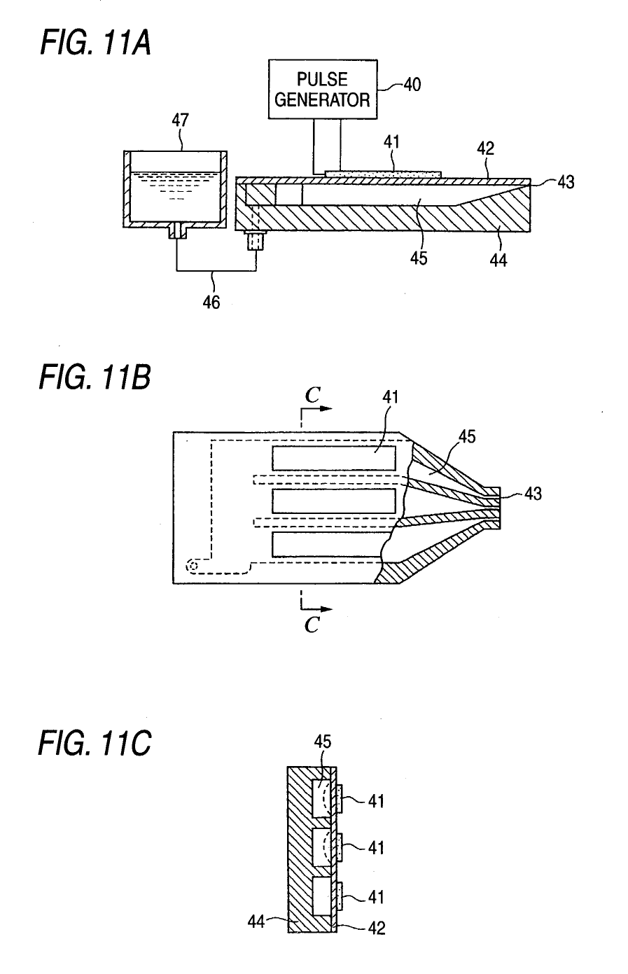

FIG. 9 is a plan view taken on line IX-IX in FIG. 8, showing the state of a piezo-electric, element pattern formed. The plurality of nozzles 11a are arrayed two-dimensionally in a matrix manner in the nozzle plate 11. In the piezoelectric plate 21, the plurality of piezoelectric elements 14a facing the nozzles 11a are arrayed in a matrix manner on the diaphragm plate 13.

Next, description will be made on the method for manufacturing the ink jet recording head according to this embodiment. First, to produce the piezoelectric elements 14a, a sheet of rectangular piezoelectric plate 21 is prepared, and a piezoelectric element pattern is formed on the piezoelectric plate 21, as shown in FIG. 9.

In the step of forming the pattern, first, a photosensitive film is applied to all over the piezoelectric plate 21 pasted onto a substrate 23, and covered with a grid-like mask. In this state, the photosensitive film is exposed and developed. By the photosensitive film (not shown) hardened and remaining in a grid manner by the development, a pattern mask including a piezoelectric element mask pattern for forming a piezoelectric element pattern 14A having eight piezoelectric elements 14a and an outer circumferential dummy mask pattern for forming 16 outer circumferential dummy patterns 52 surrounding the piezoelectric element pattern 14A is obtained. A remaining dummy mask pattern for forming a remaining dummy pattern 53 is further formed in the pattern

The remaining dummy pattern 53 is provided on the interior side of the piezoelectric element unit 14, that is, in the border portion between the piezoelectric element pattern 14A and the outer circumferential dummy patterns 52 in order that separation grooves 54 formed around the respective piezoelectric elements 14a to be arrayed two-dimensionally are identical to one another. The area which is not covered with the pattern mask is eliminated by sandblasting so that a groove pattern extending in the directions of rows and columns is obtained.

The groove pattern includes separation grooves 54a obtained due to the existence of the remaining dummy pattern 53, and separation grooves 54b obtained regardless of the remaining dummy pattern 53. The separation grooves 54a and 54b formed as gaps around the respective piezoelectric elements 14a are formed to have a substantially uniform size (±20%) all over their width. When sandblasting is carried out with the pattern mask having such a groove pattern, it is possible to obtain a plurality of piezoelectric elements 14a with processed grooves uniform in sectional shape.

FIG. 10 is a sectional view taken on line X-X in FIG. 9, showing the state where the piezoelectric, elements 14a have not yet been released from the substrate 23. When the plurality of piezoelectric elements 14a formed in the piezoelectric element unit 14 on the substrate 23 by the above described steps are mounted on the pressure chambers 12a, first, the pressure chamber plate 12 and the diaphragm plate 13 are joined onto the&nozzle plate 11 sequentially. Then, the surfaces of the respective piezoelectric elements 14a opposite to the substrate 23 are aligned with and joined to the diaphragm plate 13.

In this case, through-holes 56 are formed in the substrate 23 in advance. On the other hand, in the piezoelectric plate 21 bonded to the substrate 23 releasably, alignment marks 55 are processed in positions substantially corresponding to the through-holes 56 by sandblasting, together with the separation grooves 54a and 54b (FIG. 9) for separating the piezoelectric elements 14a from one another. Thus, the piezoelectric element unit 14 is formed. Further, the through-holes 56 of the substrate 23, the alignment marks 55, through-holes 57 of the diaphragm plate 13 forming one-side wall surfaces of the pressure chambers 12a, and positioning marks 36B formed on the pressure chamber plate 12 in advance are adjusted to one another with reference to the alignment marks 55. In this state, each piezoelectric element 14a is joined to the diaphragm plate 13 on the pressure chamber plate 12 while the pattern is inverted by 180°.

At this time, since the through-holes 56 larger than the alignment marks 55 are formed in the substrate 23 in accordance with the pitch of the alignment marks 55, alignment can be performed easily from the back side of the substrate 23. The a piezoelectric elements 14a arrayed two-dimensionally are collectively joined onto the diaphragm plate 13 (the walls of the pressure chambers 12a) with high accuracy while the positioning marks 36B are detected optically through the through-holes 56 by an optical microscope. Incidentally, when there is no through-hole 56, a transparent glass substrate may be used as the substrate 23.

Successively, the substrate 23 is released from the respective piezoelectric elements 14a fixed to the diaphragm 13. This release is carried out in the same manner as in the first embodiment. That is, the substrate 23 is heated to reduce the adhesive force of the thermo-expandable adhesive film 22. Thus, not only the step of bonding the piezoelectric element unit 14 with the substrate 23 but also the step of separating the piezoelectric element unit 14 and the substrate 23 from each other become extremely easy.

Example of Second Embodiment

In this example, there was prepared a nozzle plate 11 in which a plurality of nozzles 11a each having a diameter of 30 μm were formed in the form of a two-dimensional array of 64 rows by 4 columns. A diaphragm plate 13 made of stainless steel was joined to the pressure chamber plate 12, so as to face pressure chambers 12a communicating with the nozzles 11a respectively, as shown in FIG. 8.

Next, a sheet of piezoelectric plate 21 made of lead titanate zirconate and having a thickness of 30 μm was bonded with a substrate 23 by use of a thermo-expandable adhesive film 22. After that, patterning was performed on the piezoelectric plate 21 by use of a urethane-based photosensitive film 24. At this time, outer circumferential dummy patterns 52 each having the same shape as each piezoelectric element were provided in the outer circumference of a piezoelectric element pattern 14A. Further, a remaining dummy pattern 53 was provided on the interior side of the piezoelectric element unit 14 so that gaps around the respective piezoelectric elements 14a had a uniform size (e.g. 80 μm).

Successively, in the same manner as in the example of the first embodiment, sandblasting was performed on the piezoelectric plate 21. Also in this case, the processing time was set at 6 seconds three times as long as regular processing time. Thus, the piezoelectric elements 14a each having a rectangular shape 450 μm±5 μm in short side, 750 μm±5 μm in long side and 30 μm±1 μm in thickness were obtained. The aperture of each pressure chamber 12a showed a shape 500 μm±10 μm square.

Next, while the piezoelectric element unit 14 after the sandblasting was kept adhering to the substrate 23, an insulating resin film 15 made of polyamide and having a thickness of 10 μm was formed by vapor deposition on each of the four side surfaces of each piezoelectric element 14a. Successively, as shown in,FIG. 10, the surface of the piezoelectric element unit 14 opposite to the thermo-expandable adhesive film 22 (FIG. 7) was joined onto the diaphragm plate 13 while positioning marks 36B on the pressure chamber plate 12 were aligned with alignment marks 55 of the piezoelectric plate 21 through through-holes 57 of the diaphragm plate 13, respectively, by an optical microscope viewing through through-holes 56. In this case, the piezoelectric element unit 14 of the piezoelectric elements 14a arrayed in a matrix manner of 64 rows by 4 columns was collectively jointed to the diaphragm plate 13 with high accuracy within ±15 μm.

Here, a 0.2 μm thick metal thin film made of Cr and a 0.1 μm thick metal thin film made of Au were formed as the electrode layers 34a and 34b on the opposite sides of each piezoelectric element 14a, respectively, by a sputtering method in advance. The electrode layer 34b was bonded with the diaphragm plate 13 by conductive paste 35.

Successively, the substrate 23 was heated to reduce the adhesive strength of the thermo-expandable adhesive film 22 (FIG. 7). Then, the substrate 23 was released from the respective piezoelectric elements 14a. Further, each piezoelectric element 14a was connected to a control portion (not shown) through a solder ball bump 16 and a flexible wiring board 50. Also in the ink jet recording head manufactured thus, driving capacity similar to that of the ink jet recording head in the example of the first embodiment could be obtained.

As described above, according to the first and second embodiments, an outer circumferential dummy pattern for the outer circumference of a piezoelectric element unit is provided on a piezoelectric plate 21 bonded with a substrate, 23 so as to pattern the piezoelectric plate 21. Thus, a plurality of piezoelectric elements 14a fixedly attached to the substrate 23 can be handled collectively as a unit. As a result, the step of bonding the piezoelectric elements 14a to a diaphragm plate 13 so as to face pressure chambers 12a respectively becomes extremely easy. Accordingly, small-size ink jet recording heads each mounted with nozzles 11a arrayed in a matrix manner with high density can be mass-produced with high efficiency so that the manufacturing cost can be reduced, and inexpensive products can be obtained. Specifically, the manufacturing cost could be reduced approximately by 50% in comparison with that of any related-art ink jet recording head having the same number of nozzles 11a.

In addition, although each piezoelectric element 14a was formed to be square or rectangular in the first and second embodiments, the invention is not limited to such a configuration. Similar effect can be obtained even if each piezoelectric element 14a is formed to be hexagonal or circular. Further, although the piezoelectric elements 14a were arrayed in a matrix manner, the invention is not limited to such a configuration. The piezoelectric elements 14a may be arrayed two-dimensionally to form a circular shape as a whole. In addition, although polyamide was used for the insulating resin film 15, other resins such as fluororesin or silicone resin may be used.

Third Embodiment

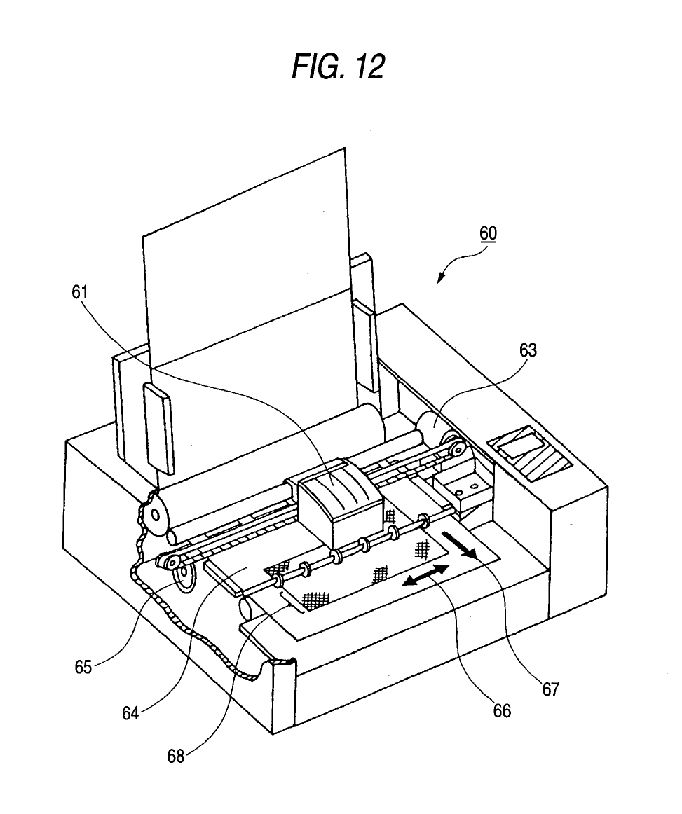

FIG. 12 is a perspective view showing an embodiment of an ink jet recording apparatus according to the invention. An ink jet recording apparatus 60 in this embodiment is constituted by a carriage 61 mounted with an ink jet recording head, a main-scanning mechanism 63 for making the carriage 61 scan in a main-scanning direction 66, and a sub-scanning mechanism 65 for feeding recording paper 64 as a recording medium in a sub-scanning direction 67.

The ink jet recording head is mounted on the carriage 61 so that the nozzle surface faces the recording paper 64. The ink jet recording head ejects ink droplets to the recording paper 64 while being conveyed in the main-scanning direction 66. Thus, the ink jet recording head achieves recording on a constant band area 68. Next, the recording paper 64 is fed in the sub-scanning direction 67, and recording is carried out on the next band area while the carriage 61 is conveyed again in the main-scanning direction 66. Such an operation is repeated a plurality of times. Thus, an image can be recorded all over the recording paper 64.

Practically, image recording was performed by use of the ink jet recording apparatus 60 so that the recording speed and the image quality were evaluated. An ink jet recording head having the same head structure as described in the second embodiment was used. Matrix array heads corresponding to four colors of yellow, magenta, cyan and black and having 256 ejectors (64 rows by 4 columns) per color were arrayed and disposed on the carriage 61 so as to lay dots of the four colors on one another on the recording paper 64. Thus, full color image recording was performed. As a result, uniformity within ±3% was obtained among the volumes of ink droplets ejected from the respective ejectors, and an output image with high image quality could be obtained. That is, in the ink jet recording apparatus 60 according to this embodiment, it was proved that piezoelectric elements had dimensional uniformity extremely high to prevent fluctuating in properties among the ejectors, so that a high-quality image could be output.

Incidentally, although this embodiment adopts a mode in which recording is performed while the head is conveyed by the carriages the invention is applicable to other apparatus configurations. For example, a line head in which nozzles are disposed all over the width of a recording medium may be used so that the head is fixed to perform recording while feeding only the recording medium.

The invention has been described above on the basis of its first and second preferred embodiments and their examples, and its third preferred embodiment. However, an ink jet recording head, a manufacturing method thereof and an ink jet, recording apparatus according to the invention are not limited to only the configurations of the embodiments and the examples. The scope of the invention also includes an ink jet recording head, a manufacturing method thereof, and an ink jet recording apparatus, in which various modifications and changes are given to the configurations of the embodiments and the examples.

For example, although sandblasting was performed on a piezoelectric plate bonded to a substrate so as to form a piezoelectric element unit in the first and second embodiments, sandblasting may be performed, instead, on a piezoelectric plate bonded onto a diaphragm plate so as to form a piezoelectric element unit directly on the diaphragm plate.

In addition, although nozzles were arranged in an approximately grid-like array in the first and second embodiments, the nozzle array is not limited to such an approximately grid-like array. The invention is also applicable to cases where other two-dimensional array methods are used.

In addition, although an ink jet recording head and an ink jet recording apparatus for ejecting coloring ink onto recording paper so as to record characters, images or the like thereon were described in the first to third embodiments by way of example, ink jet recording in this specification is not limited to recording of characters or images on recording paper. That is, the recording medium is not limited to paper and liquid to be ejected is not limited to coloring ink. The invention can be also used in a general liquid droplet ejection apparatus used industrially. For example, the invention may be used for ejecting coloring ink onto a polymeric film or glass so as to produce a color filter for a display, or for ejecting fused solder onto a substrate so as to form bumps for mounting components.

An outer circumferential or remaining dummy pattern is provided to form uniform-width grooves around a piezoelectric element unit as described above. However, the shape and arrangement of the piezoelectric element unit may be devised to form uniform-width grooves without providing any dummy pattern.

As described above, according to the invention, it is possible to obtain a method for easily manufacturing a large number of piezoelectric elements arrayed two-dimensionally with high density in the form of a matrix array head by a simple manufacturing process while a piezoelectric plate is formed into a desired shape, and to obtain an ink jet recording head manufactured in such a manufacturing method, and an ink jet recording apparatus mounted with such an ink jet recording head.

What is claimed is:

1. A method for manufacturing an ink jet print head, the method comprising the steps of:
forming a mask pattern on a piezoelectric plate;
sandblasting the piezoelectric plate to divide the piezoelectric plate into a plurality of piezoelectric element units; and
positioning the piezoelectric plate so that each of piezoelectric element units corresponds to each of a plurality of pressure chambers,
wherein in the forming step, the mask pattern is formed so that grooves formed around the piezoelectric element units have a uniform width.

2. The method according to claim 1, further comprising the steps of boding the piezoelectric plate on a substrate removably,
wherein in the positioning step, the piezoelectric plate is bonded to a diaphragm plate so that each of piezoelectric element units corresponds to each of pressure chambers.

3. The method according to claim 1,
wherein the mask pattern has first areas corresponding to the piezoelectric element units and second areas adjacent to the first areas with a predetermined gap therebetween; and
wherein the sandblasting step forms the piezoelectric element units and a plurality of dummy patterns having the predetermined gap therebetween.

4. The method according to claim 3, wherein the dummy patterns are formed in an outer circumferential portion of the piezoelectric element units.

5. The method according to claim 3, wherein the dummy patterns are formed between the adjacent piezoelectric element units.

6. The method according to claim 3,
wherein the piezoelectric element units are arranged in a two-dimensional matrix manner; and
wherein the dummy patterns are formed between the piezoelectric element units being adjacent in the diagonal direction.

7. An ink jet head comprising:
a plurality of chambers; and
a plurality of piezoelectric element units arranged to correspond to the chambers,
wherein driving each of piezoelectric element units applies pressure to each of chambers to eject an ink droplet; and
wherein grooves are formed around the piezoelectric element units.

8. The ink jet head according to claim 6,
wherein piezoelectric element areas making no contribution to driving the piezoelectric element units are formed adjacently to the piezoelectric element units; and
wherein the grooves are formed around the piezoelectric element units by the piezoelectric element areas to have a uniform width.
